(19) United States
(12) Patent Application Publication
(10) Pub. No.: US 2008/0310427 A1
(43) Pub. Date: Dec. 18, 2008

(54) Method of Determining Reliability of Information

(75) Inventor: Mark Alan West, Southampton Hampshire (GB)

Correspondence Address: CROWELL & MORING LLP;INTELLECTUAL PROPERTY GROUP, P.O. BOX 14300, WASHINGTON, DC, 20044-4300, US

(73) Assignee: ROKE MANOR RESEARCH LIMITED, ROMSEY HAMPSHIRE (GB)

(21) Appl. No.: 11/666,341

(22) PCT Filed: Oct. 19, 2005
(86) PCT No.: PCT/GB05/04017

§ 371 Date: Mar. 20, 2008

(30) Foreign Application Priority Data
Oct. 27, 2004 (GB) 0423848.1

(51) Int. Cl. H04L 12/56

(52) U.S. Cl. 370/400

(57) ABSTRACT

A method of determining reliability of information received at a destination (16) in a communication network sent from a source with which the destination does not have a security association comprises generating first and second data (12, 13) representative of the information at the source. The first data is sent down a first route (14) from the source to the destination and the second data is sent down a second route (15) from the source to the destination. At the destination, received data that has been sent via the first and second routes (14, 15) is compared. Information is regenerated from the received data and the reliability of the information is determined from the result of the comparison of the received data.

This invention relates to a method of determining reliability of information received at a destination in a communication network, sent from a source with which the destination does not have a security association.

There are various situations in which it is desirable to determine whether data which has been received is the same as the data which was originally sent. There may be occasions when the consequences of using data which has been tampered with in some way are significant. Examples in the context of banking include an instruction to transfer a particular amount of money to a specific bank account which would cause problems if the wrong amount of money was transferred, or if the correct amount was transferred, it went to the wrong account. In merchant banking where the sums involved may run to millions, then the consequences could impact on matters outside the bank itself.

Another example is for businesses sending data relating to potential breaches of security in their IT systems. In some cases, the response to a perceived virus attack is to shut down the system links to the outside world, but in this day and age, the outcome can be that the business of the company is brought to a standstill, therefore such an action should only be taken if there is a high degree of confidence in the accuracy of the apparent breach.

In accordance with a first aspect of the present invention, a method of determining reliability of information received at a destination in a communication network, sent from a source with which the destination does not have a security association comprises generating first and second data representative of the information at the source; sending the first data down a first route; sending the second data down a second route; comparing at the destination, received data that has been sent via the first and second routes; regenerating the information from the received data; and determining the reliability of the information from the result of the comparison of the received data.

In accordance with a second aspect of the present invention, communication apparatus comprises a source terminal, including a splitter; and a destination terminal, including a recombiner and a processor; wherein the source terminal and the destination terminal do not have a security association; means for generating first and second data from information at the source terminal; at least two routes for sending the first and second data respectively between the source and destination terminal; wherein the first data is sent down a first route from the source terminal to the destination terminal; wherein the second data is sent down a second route from the source terminal to the destination terminal; wherein received data sent via the first and second routes is compared at the destination terminal; and means for regenerating the information from the received data; wherein the processor determines the reliability of the regenerated information from the result of the comparison of the received data.

Preferably, the first and second data are identical.

Preferably, the second route is substantially independent of the first route.

Preferably, the data is sent in packets.

Preferably, the second data is a hash of the first data.

Preferably, the first data and its related hash are sent randomly on their respective routes.

Preferably, the first data comprises data which has been encrypted using a key and the second data comprises the key.

Preferably, the method further comprises sending third data down a third route.

Preferably, the third data is identical to the first data.

An example of a method of determining reliability of information received at a destination in a communication network, sent from a source with which the destination does not have a security association, according to the present invention will now be described with reference to the accompanying drawings in which:

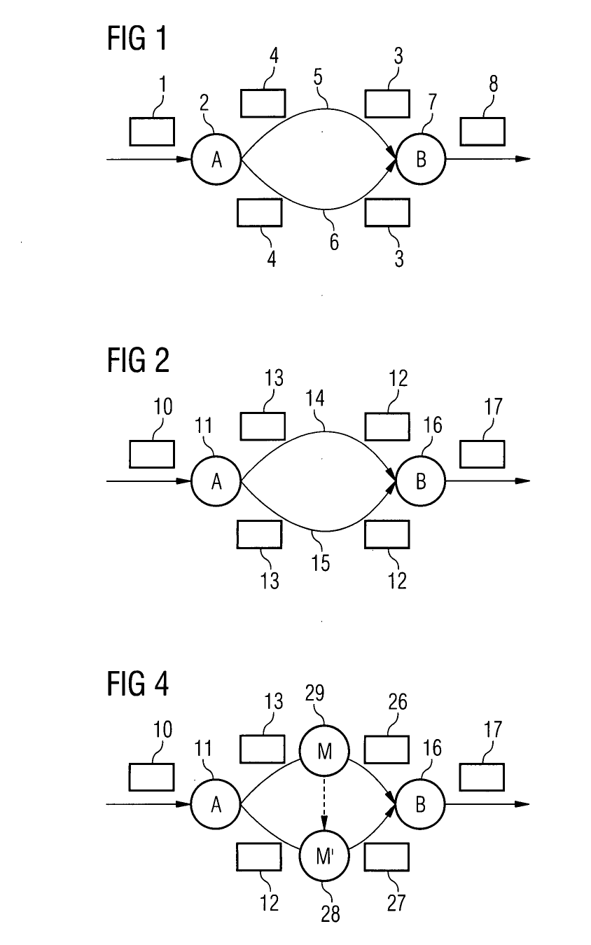

FIG. 1 illustrates a conventional method of achieving resilience in packet flows;

FIG. 2 illustrates a first example of a method of determining reliability of data received at a terminal of a communication network according to the present invention; and,

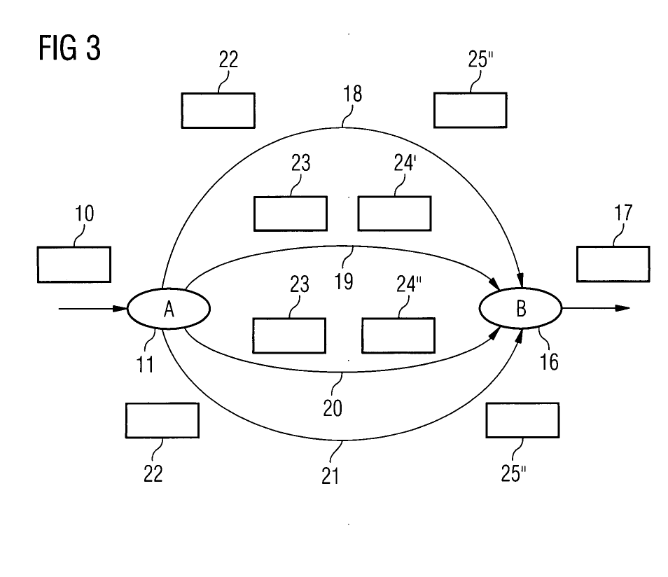

FIG. 3 shows a modified example of the method described with respect to FIG. 2; and,

FIG. 4 illustrates another example of the method of the present invention.

For the purpose of this invention, the expression “security association” refers to an end to end relationship that defines the trust between two entities and the way in which they can communicate securely, even over untrusted links.

FIG. 1 illustrates an example of a method of improving resilience of data packet flows. A message 1 is passed through a first node 2 where the message packets are replicated. Packets 3, 4 are sent via two independent routes 5, 6 to a second node 7 where they are recombined to produce a reformed message 8. Where both packets get through successfully, one is dropped, but if one packet is lost, then that packet is used to recreate the message, irrespective of the route which it took. This system, although improving resilience, does not address the possibility that a packet on one route has been intercepted and replaced with another packet, which is then assumed to be correct, provided that no conflicting packet gets through on the other route.

FIG. 2 illustrates a first example of a method of determining reliability of data received at a destination in a communication network according to the present invention. A message 10 at a node 11 is split into packets for sending. The same packets 12, 13 are sent via two independent routes 14, 15. This embodiment of the invention duplicates packets down multiple, disparate routes and re-combines them at the other end, using a splitter and re-combiner 16. If there is only one packet received, or the two received packets are not the same when the reach the recombiner, they are assumed to be suspect and an indication to this effect is provided with an output message 17. This method takes advantage of existing infrastructure, so no other devices or security-specific configurations are required. The invention is able to operate with systems where there is no pre-existing security association and is particularly applicable to situations where it would be impossible to set up such a security association, for example for transmission via one-way satellite links, where there is no mechanism for negotiating a dynamic security association.

For packets arriving at the combiner, only certain fields will be expected to have changed in the packet headers (e.g. time-to-live/hop-count) and nothing in the packet payload. Thus, rather than simply performing the recombination and attempting to recreate the input packet flow without loss, the packets arriving at the recombiner are compared. If matched pairs of packets do not match, then the integrity of those packets cannot be guaranteed. In this case, there is no additional resilience, since both packets are required to arrive in order to verify the integrity and double the capacity is required in the transit network.

The present invention aims to improve the security of a flow of packets between two points in a network, without requiring a complex support infrastructure or modification of the existing infrastructure. Conventional ways of making packet flows harder to intercept or modify, such as IP security protocol (IPsec), tend to be concerned with ‘absolute’ security and require some form of infrastructure in order to operate. In other words, existing security mechanisms require some form of negotiation or out-of-band exchange (e.g. ‘pre-sharing’ of keys) as well as some degree of bandwidth overhead. Without an end to end security association, terminals would not normally trust the data sent from one to another, even if the links between them were deemed to be “secure”. This invention requires only a comparable degree of bandwidth overhead, but no other configuration or setting up, so it provides a relatively low cost, easily implemented solution. In many cases, the security will be extremely good—the only overhead is additional bandwidth, and this is minimised by the invention. Also, since there is no negotiation required between the sender and receiver, the method of the present invention is able to operate over a network containing a number of one-way links.

The basic method described above can be further modified to increase the security and reduce the load on the network as shown in FIG. 3. Instead of the packets 12 and 13 of the message 10 being replicated and sent down two separate paths 14, 15, a hash of the packet is computed and packets and hashes are randomly split across n paths (n>=2). FIG. 3 illustrates an example with four paths. Another advantage of making the number of paths>2 is that packets can be replicated as a way of adding resilience as well. For example, in the situation shown where four paths 18, 19, 20, 21 are available, and two packets 22, 23 are being sent, for each of which a 20-byte SHA-1 hash 24, 25 had been computed: the first packet is sent down paths 18 and 21, whilst 10 bytes 24′ of the hash 24 are sent down path 19 and 10 bytes 24″ of the hash 24 are sent down path 20. The second packet might be sent down paths 19 and 21, whilst 10 bytes 25′ of the hash 25 are sent down path 18 and 10 bytes 25″ of the hash 25 are sent down path 20. Other arrangements are possible.

The recombiner 16 considers a packet to have assured integrity if at least one copy of the packet 22, 23 and a valid hash 24, 25 for that packet arrives. The recombiner can monitor the different latencies of the paths and have a time window within which it accepts the packet/hash combination. Data arriving outside of this window is assumed to have been modified without authorisation.

FIG. 4 illustrates another example of the method of the present invention where the message 10 is split in the splitter 11 into packets 12, 13 and a hash 26, 27 of each packet is calculated. The packets 12, 13 and the hashes 26, 27 are passed through nodes M and M′ 28, 29 which are assumed to be compromised. The example of FIG. 2 made it hard to damage the integrity of the packet flow because the same change had to be made to both copies of the packet in the network in order to change the output. The example of FIG. 4 goes further in that an attacker must modify both packets and the hash in transit. This presumes that information about the content of the packet can be conveyed near-instantaneously between the two, or more, compromised nodes 28, 29. This implies that it is also hard for an eavesdropper to reconstruct whole sessions, other than by using multiple points within the network. This security, which offers integrity protection only, is achieved without the need for any key distribution. The security is inherent in the path diversity and the difficulty of modifying the packet and the packet hash within a suitable time-frame.

The method of the present invention uses a device that is able to split a packet flow and send it down multiple, non-overlapping routes 14, 15, then recombine and check the data. A splitter 11 and combiner 16 are used, where the splitter modifies the packet flow in some way, such as by computing some form of strong checksum over the packet; or encrypting a packet with a random key, then makes a random choice to send each packet over one of n routes and re-combines the packets into a single flow at the combiner. The combiner 16 computes or verifies some form of strong checksum over the packet; or decrypts the packet according to the action applied at the input. Apart from any necessary modifications to the splitter and combiner to enable the checksum or encryption to be applied or decoded, no additional devices are required to provide security. This device makes it very hard to intercept or modify packets, despite it relying on existing infrastructure and the device can also provide some or all of the resilience features of an active-active resilient system. The device can also control the bandwidth utilised by the system and provides a form of ‘keyless’ security.

An alternative embodiment of this invention involves encrypting each packet with a different random key and sending encrypted packets by one path and the key via the diverse path. The key, in this case, is chosen via a suitably cryptographically strong pseudo-random number generator. The overhead is similar to the hash/checksum one: assuming that the packet is sent down one path and the key down another. Some form of integrity check can be included. The effect of combining key encryption with multiple paths is that an eavesdropper cannot possibly interpret the packet without access to both paths; so listening on a single path reveals no information. Likewise, to modify a packet requires the eavesdropper to get both packet and key.

An alternative to strict pseudo-random generation of the key sequence for this method is to use a weak security mechanism known as a reverse hash chain. In this, the sender picks a random number N and then computes a secure hash (e.g. SHA-1) of N (giving N1). This repeats, computing the hash of each hash. So, N1 is hashed to get N2, etc. The hashes are then used as the keys in reverse order. It is impractical for an adversary to predict the key sequence, since the hash is cryptographically strong. However, it is trivial to verify that each hash is the next one in the expected sequence, when revealed. This provides additional verification that packets have been received from the same, perhaps anonymous, sender as the previous packets.

All of the methods described are able to work across networks containing uni-directional links. They are able to combine security and resilience; provide authentication or privacy at low overhead without infrastructure; and do not require a keying infrastructure or configuration.

1.-19. (canceled)

20. A method of determining reliability of information received at a destination in a communication network sent from a source with which the destination does not have a security association; the method comprising generating first data and second data representative of the information at the source, sending the first data down a first route from the source to the destination; sending second data down a second route from the source to the destination; comparing at the destination, received data that has been sent via the first and second routes; regenerating the information from the received data; wherein the data for comparison is received within a time window and if received outside the time window, is assumed to have been modified; and wherein, if within the time window, determining the reliability of the information from the result of the comparison of the received data.

21. A method according to claim 20, wherein the first and second data are identical.

22. A method according to claim 20, wherein the second route is substantially independent of the first route.

23. A method according to claim 20, wherein the data is sent in packets.

24. A method according to claim 20, wherein the second data is a hash of the first data.

25. A method according to claim 24, wherein the first data and its related hash are sent randomly on their respective routes.

26. A method according to claim 20, wherein the first data comprises data which has been encrypted using a key and the second data comprises the key.

27. A method according to claim 20, further comprising sending third data down a third route.

28. A method according to claim 27, wherein the third data is identical to the first data.

29. Communication apparatus comprising a source terminal, including a splitter; and a destination terminal, including a recombiner and a processor; wherein the source and destination terminal do not have a security association; means for generating first and second data from information at the source terminal; at least two routes for sending the first and second data respectively between the source and destination terminal; wherein the first data is sent down a first route from the source terminal to the destination terminal; wherein second data is sent down a second route from the source terminal to the destination terminal; wherein received data sent via the first and second routes is compared at the destination terminal; and means for regenerating the information from the received data; wherein the data is received within a time window and if received outside the time window, is assumed to have been modified; wherein, if within the time window; and wherein the processor determines the reliability of the regenerated information from the result of the comparison.

30. Apparatus according to claim 29, wherein the first and second data are identical.

31. Apparatus according to claim 29, wherein the second route is substantially independent of the first route.

32. Apparatus according to claim 29, wherein the data is sent in packets.

33. Apparatus according to claim 29, comprising means for generating a hash of the first data; and sending the hash as the second data.

34. Apparatus according to claim 33, wherein the first data and its related hash are sent randomly on their respective routes.

35. Apparatus according to claim 29, further comprising means for encrypting the first data using a key and sending the key as the second data.

36. Apparatus according to claim 29, further comprising sending third data down a third route.

37. Apparatus according to claim 36, wherein the third data is identical to the first data.
